(19) United States
(12) Patent Application Publication
(10) Pub. No.: US 2007/0218301 A1
(43) Pub. Date: Sep. 20, 2007

(54) Tinted anti-fingerprint coating on 430 stainless steel for appliances

(76) Inventors: Justin Allen Pachuta, Evansville, IN (US); Franklin George Katje, Evansville, IN (US); David Lloyd Benefiel, Oakland City, IN (US)

Correspondence Address: WHIRLPOOL PATENTS COMPANY - MD 0750, 500 RENAISSANCE DRIVE - SUITE 102, ST. JOSEPH, MI, 49085, US

(21) Appl. No.: 11/376,072

(22) Filed: Mar. 15, 2006

(51) Int. Cl. B32B 15/04

(52) U.S. Cl. 428/457

(57) ABSTRACT

An appliance having exterior parts with an outer surface fabricated from 430 stainless steel, and having a clear, tinted coating over the 430 stainless steel to duplicate the color of 304 stainless steel. An outer surface material for an exterior appliance part is formed of a sheet of 430 stainless steel coated with a clear, tinted material to provide a color appearance to the exterior appliance part material of that of 304 stainless steel.

### BACKGROUND OF THE INVENTION

The present invention relates generally to appliance cabinets, doors, trim parts, consoles, and any other exterior surfaces and parts of the products and in particular to a surface coating for these parts that are created in stainless steel.

Exterior surface materials for appliances, such as refrigerators, ovens, dishwashers, etc., typically include various steels, the particular type depending upon the finish being applied to the steel, such as paint or merely a polished or brushed finish. When the polished or brushed finish is desired, generally grade 304 stainless steel is used which has excellent forming and welding characteristics, and also contains about 18% chromium and 8% nickel which give it a bright silver color and appearance. When several appliances are to be used together, such as in a kitchen environment, it is desirable that all of the appliances with similar polished or brushed metal finishes, be made of the same material so that they each have a similar color and appearance.

Other stainless steel grades, such as grade 430, while having similar forming and welding characteristics, and perhaps better characteristics for exterior surface parts for appliances, such as higher resistance to permanent denting, have not been able to be used effectively in appliance cabinets, despite the generally lower cost of grade 430, in that grade 430 contains no nickel and therefore has a different color and appearance than grade 304 stainless steel.

A drawback of polished or brushed stainless steel finishing material is that it readily shows fingerprints and the oils deposited from fingers smear on the finish, requiring the entire cabinet to be polished to remove the appearance of the fingerprints, not just the local area where the fingerprints were left.

It is known to coat stainless steel articles, such as disclosed in U.S. Pat. No. 6,890,658 in which a stainless steel substrate is coated with a transparent resin film, the resin film comprising a transparent synthetic resin base and a transparent heat-sensitive adhesive layer formed on the synthetic resin base on the side of the stainless steel substrate, and the resin film being bonded to the stainless steel substrate through a silane coupling agent.

It would be an improvement in the art if a coating were provided for stainless steel which would reduce the appearance of fingerprints and allow easy removal of fingerprints, and also to give a grade 430 stainless steel the appearance of grade 304 stainless steel.

### SUMMARY OF THE INVENTION

In an embodiment an appliance is provided, in whole or in part, with an exterior surface finish having the surface fabricated from 430 stainless steel, and having a clear, tinted coating over the 430 stainless steel to duplicate the color of 304 stainless steel.

In an embodiment, the 430 stainless steel has a brushed finish or a rolled on brushed-like finish.

In an embodiment, an outer finish material for an exterior surface for an appliance is provided comprising a sheet of 430 stainless steel coated with a clear, tinted material to provide a color appearance to the outer finish of that of 304 stainless steel.

In an embodiment, a method of fabricating an outer surface finish material for an appliance exterior surface is provided, including the steps of:
selecting a roll of 430 stainless steel with a desired surface finish,
applying a tinted clear coating to the roll of 430 stainless steel to provide a color appearance to the 430 stainless steel of that of 304 stainless steel,
heat curing the coating,
severing a portion of the roll of 430 stainless steel, and
forming the portion into an appliance exterior surface finish part.

These and other aspects and details of the present invention will become apparent upon a reading of the detailed description and a review of the accompanying drawings. Specific embodiments of the present invention are described herein. The present invention is not intended to be limited to only these embodiments. Changes and modifications can be made to the described embodiments and yet fall within the scope of the present invention.

### BRIEF DESCRIPTION OF THE DRAWINGS

FIG. 1 is a schematic perspective view of an appliance embodying the principles of the present invention.

FIG. 2 is a partial side view of an appliance exterior surface finish material embodying the principles of the present invention.

### DETAILED DESCRIPTION OF THE PREFERRED EMBODIMENTS

The present invention provides an outer finishing material for an appliance, an appliance having an outer finish made from such material and a method for making the outer finishing material.

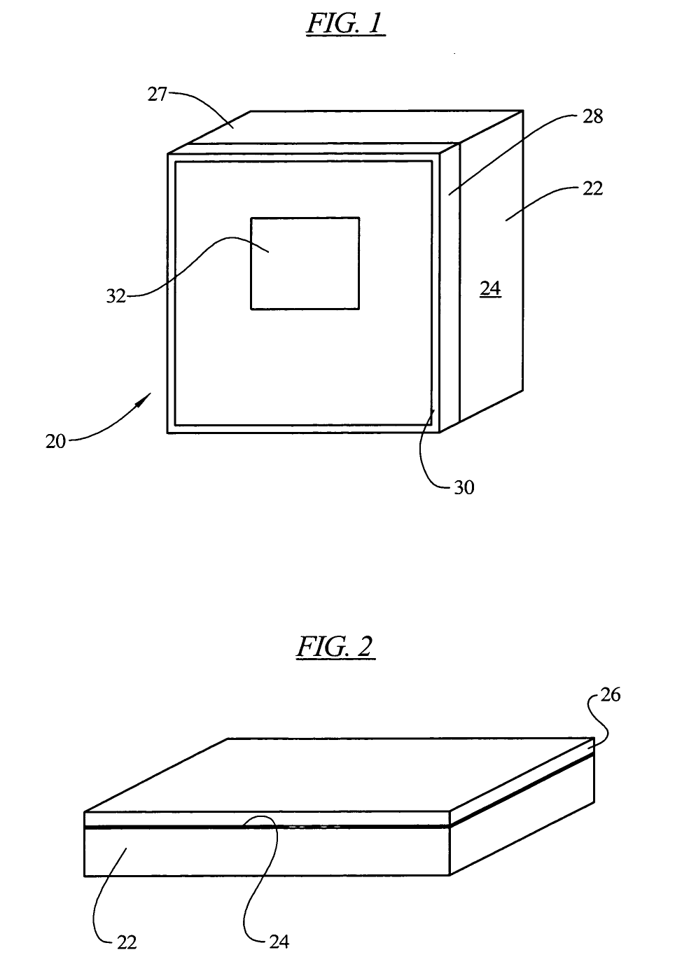

As illustrated in FIG. 1, an appliance 20 is provided with an exterior surface material 22 having an outer surface 24 and being fabricated from 430 stainless steel. A clear, tinted coating material 26 (FIG. 2) is applied over the 430 stainless steel of the exterior surface material 22 to duplicate the color of 304 stainless steel and to provide an easily cleanable surface that will not show fingerprints as readily as uncoated stainless steel. The appliance exterior surface material 22 may be used in the fabrication of the appliance cabinet, doors, trim parts, consoles and other exterior surfaces and parts of the appliance. The appliance can be any of generally available domestic appliances, including: refrigerators, freezers, icemakers, ovens, stoves, exhaust hoods, cooktops, ranges, dishwashers, trash compactors, washers, dryers, etc. The entire exterior surface of the appliance, including a cabinet wrapper 27, may be exterior surface material 22 fabricated from the coated 430 stainless steel, such as when the appliance 20 is a stand-alone model. Alternatively, just a portion of the appliance exterior may be fabricated from this exterior surface material 22, such as a door 28, a trim part 30 or a console 32 of the appliance 20, particularly when the appliance is a built-in model.

The 430 stainless steel selected for the appliance exterior surface material 22 may have one of a variety of finishes, such as a brushed finish, a rolled on brushed-like finish or a polished finish, depending upon the desired final look for the appliance.

As illustrated in FIG. 2, the appliance exterior surface material 22 comprises a sheet of 430 stainless steel which is coated with the clear, tinted material 26 to provide a color appearance to the appliance surface finish of that of 304 stainless steel. The coated surface 24 may be provided with a desired finish before the coating material 26 is applied. The coating material 26 may be applied while the appliance exterior surface material 22 is still in a coil form or it may be applied after the appliance exterior surface material is cut and formed to the desired shape. The coating material 26 may be applied directly to the appliance exterior surface material 22, without an intervening materials.

Through various tests, it has been determined that a polyester based coating meets performance requirements for the material, while having an acceptable cost. Polyurethane based coatings are generally too expensive, while epoxy based coatings do not meet performance requirements. The tinting in the coating is provided by organic compounds.

In an embodiment, a method of fabricating an outer appliance surface finish material for an appliance exterior surface part is provided, including the steps of:
selecting a roll of 430 stainless steel with a desired surface finish, such as a brushed or brushed-like finish or a polished finish,
applying a tinted clear coating to the roll of 430 stainless steel to provide a color appearance to the 430 stainless steel of that of 304 stainless steel,
curing the coating, such as by air drying or heat curing,
severing a portion of the roll of 430 stainless steel, and
forming the portion into an exterior appliance part.

The present invention has been described utilizing particular embodiments. As will be evident to those skilled in the art, changes and modifications may be made to the disclosed embodiments and yet fall within the scope of the present invention. For example, various components could be utilized separately or independently in some embodiments without using all of the other components in the particular described embodiment. In other embodiments, different combinations of components than those combinations specifically shown and described could be used. The disclosed embodiments are provided only to illustrate aspects of the present invention and not in any way to limit the scope and coverage of the invention. The scope of the invention is therefore to be limited only by the appended claims.

As is apparent from the foregoing specification, the invention is susceptible of being embodied with various alterations and modifications which may differ particularly from those that have been described in the preceding specification and description. It should be understood that we wish to embody within the scope of the patent warranted hereon all such modifications as reasonably and properly come within the scope of our contribution to the art.

The embodiments of the invention in which an exclusive property or privilege is claimed are defined as follows:

1. An appliance comprising:
an exterior part having an outer surface fabricated from 430 stainless steel, and having a clear, tinted coating over the 430 stainless steel to duplicate a color of 304 stainless steel.

2. An appliance according to claim 1, wherein the 430 stainless steel has a brushed or brushed-like finish.

3. An appliance according to claim 1, wherein the appliance is a refrigerator.

4. An appliance according to claim 1, wherein the appliance is a dishwasher.

5. An appliance according to claim 1, wherein the appliance is a stove.

6. An appliance according to claim 1, wherein the appliance is a freezer.

7. An appliance according to claim 1, wherein the appliance is a trash compactor.

8. An appliance according to claim 1, wherein the appliance is an oven.

9. An appliance according to claim 1, wherein the appliance is a range.

10. An appliance according to claim 1, wherein the appliance is an icemaker.

11. An appliance according to claim 1, wherein the exterior part is a door.

12. An appliance according to claim 1, wherein the exterior part is a cabinet wrapper.

13. An appliance according to claim 1, wherein the exterior part is a trim part.

14. An appliance according to claim 1, wherein the exterior part is a console.

15. An appliance surface finish material for an appliance cabinet comprising a sheet of 430 stainless steel coated with a clear, tinted material to provide a color appearance to the appliance surface finish material of that of 304 stainless steel.

16. An outer appliance surface finish material according to claim 15, wherein the 430 stainless steel has a brushed or brushed-like finish.

17. A method of fabricating an outer appliance surface finish material for an appliance cabinet, comprising the steps of:
selecting a roll of 430 stainless steel with a desired surface finish,
applying a tinted clear coating to the roll of 430 stainless steel to provide a color appearance to the 430 stainless steel of that of 304 stainless steel, curing the coating,
severing a portion of the roll of 430 stainless steel, and
forming the portion into an exterior appliance part.

18. A method according to claim 17, wherein the selected 430 stainless steel has a brushed or brushed-like finish.

19. A method according to claim 17, wherein the steps of severing and forming occur after the steps of applying and curing.

20. A method according to claim 17, wherein the steps of severing and forming occur prior to the steps of applying and curing.
